(19) United States
(12) Patent Application Publication
(10) Pub. No.: US 2025/0294321 A1
(43) Pub. Date: Sep. 18, 2025

(54) SYSTEMS AND METHODS FOR DETECTING OBJECT IN VEHICLE BASED ON ULTRA-WIDEBAND

(71) Applicants: Hyundai Motor Company, Seoul (KR); Kia Corporation, Seoul (KR)

(72) Inventors: Xu Qiang Sun, Shandong (CN); Guofeng Jin, Shandong (CN)

(21) Appl. No.: 19/081,513

(22) Filed: Mar. 17, 2025

(30) Foreign Application Priority Data
Mar. 18, 2024 (CN) 202410308674.1

(51) Int. Cl. H04W 4/029; B60Q 9/00; B60R 16/023; E05B 81/76; H04W 4/48; H04W 4/80

(52) U.S. Cl. CPC H04W 4/029; B60Q 9/00; B60R 16/0231; H04W 4/48; H04W 4/80; E05B 81/77

(57) ABSTRACT

The present disclosure relates to systems and methods for detecting an object in a vehicle based on ultra-wideband (UWB). The system may comprise a vehicle-mounted UWB communication device comprising a UWB processing module and a plurality of vehicle-mounted UWB communication modules. The UWB processing module is communicatively connected to the plurality of vehicle-mounted UWB communication modules, the plurality of vehicle-mounted UWB communication modules are configured to perform UWB communication with the object and transmit a received UWB communication signal of the object to the UWB processing module, and the UWB processing module is configured to determine location information of the object based on the UWB communication signal and convert the determined location information of the object into a vehicle-mounted communication signal. The system may comprise a vehicle-mounted control device configured to generate a corresponding control signal and a vehicle-mounted display device.

### CROSS-REFERENCE TO RELATED APPLICATION

This application claims, under 35 U.S.C. § 119 (a), the benefit of Chinese Patent Application No. 202410308674.1 filed in the Chinese National Intellectual Property Administration on Mar. 18, 2024, the disclosure of which is incorporated herein by reference in its entirety.

### BACKGROUND

### Technical Field

The present disclosure relates to detection and control technologies for a vehicle and, more particularly, to systems and methods for detecting an object in a vehicle, such as a car key or a mobile device, based on ultra-wideband (UWB).

### Background

As science and technology continue to develop, people's demands for vehicle intelligence and comfort are increasing. While driving a vehicle, a car key and a mobile device (e.g., mobile phone, tablet, etc.) are items that a driver frequently uses. When a driver forgets a location of the car key (or mobile phone) or accidentally drops the car key under a seat or in a small corner and does not know an exact location of the car key, it may be very troublesome to find the car key. When there are too many clutters in the car or children play with the car key, the car key may be hidden and difficult to find.

In addition, when the driver wants to connect to other's mobile phones via Bluetooth® (e.g., mobile address book, Bluetooth® music, etc.) while riding in the car, he/she should use the setting function to turn on the Bluetooth® function, find the corresponding Bluetooth® name in the list, and then perform the Bluetooth® connection. In other words, there is currently no function to connect to other's mobile phones via Bluetooth® with one click.

However, an existing management system for car keys and mobile devices based on low-power Bluetooth® (BLE) technology still has shortcomings. For example, the system may only achieve low positioning accuracy for the car keys and the mobile devices, making it difficult to manage the car keys and the mobile devices efficiently. Therefore, it is necessary to improve the shortcomings of the existing technology in order to provide a more efficient and accurate system and method for detecting car keys and mobile devices based on ultra-wideband (UWB).

The above information disclosed in this Background is only for the enhancement of understanding of the background of the present disclosure and, therefore, may contain information that does not form the background information that is already known in this country to a person of ordinary skill in the art.

### SUMMARY

The present disclosure attempts to provide a system and a method for accurately detecting a location of an object such as a car key or a mobile device.

In one aspect, a system for detecting an object in a vehicle based on ultra-wideband (UWB) is provided, the system comprising: 1) a vehicle-mounted UWB communication device comprising a UWB processing module and a plurality of vehicle-mounted UWB communication modules; 2) a vehicle-mounted control device communicatively connected to the vehicle-mounted UWB communication device; and 3) a vehicle-mounted display device communicatively connected to the vehicle-mounted control device, wherein: i) the object comprises a UWB communication module and is configured to transmit and receive a UWB communication signal, ii) the UWB processing module and the plurality of vehicle-mounted UWB communication modules are communicatively connected to each other, iii) the plurality of vehicle-mounted UWB communication modules are configured to perform UWB communication with the object and transmit the received UWB communication signal of the object to the UWB processing module, the UWB processing module is configured to: a) determine location information of the object based on the received UWB communication signal of the object, and b) convert the determined location information of the object into a vehicle-mounted communication signal, the vehicle-mounted control device is configured to generate a corresponding control signal based on the vehicle-mounted communication signal of the vehicle-mounted UWB communication device, and the vehicle-mounted display device is configured to, based on the control signal of the vehicle-mounted control device, display, in the vehicle, one or more of the following: a three-dimensional image of the vehicle; a position icon; and voice prompt information of the object in the vehicle.

According to an exemplary embodiment of the present disclosure, there is provided a system for detecting an object in a vehicle based on ultra-wideband (UWB). The object may be provided with a UWB communication module and transmit and receive a UWB communication signal. The system for detecting an object in a vehicle based on UWB comprises a vehicle-mounted UWB communication device that is provided with a UWB processing module and a plurality of vehicle-mounted UWB communication modules, in which the UWB processing module and the plurality of vehicle-mounted UWB communication modules are communicatively connected to each other, the plurality of vehicle-mounted UWB communication modules perform UWB communication with the object and transmit the received UWB communication signal of the object to the UWB processing module, the UWB processing module is configured to determine location information of the object based on the received UWB communication signal of the object and convert the determined location information of the object into a vehicle-mounted communication signal; a vehicle-mounted control device that is communicatively connected to the vehicle-mounted UWB communication device, in which the vehicle-mounted control device is configured to generate a corresponding control signal based on the vehicle-mounted communication signal of the vehicle-mounted UWB communication device; and a vehicle-mounted display device that is electrically connected to the vehicle-mounted control device, in which the vehicle-mounted display device is configured to display a three-dimensional image of the vehicle and a position icon and/or a voice prompt information of the object in the vehicle based on the control signal of the vehicle-mounted control device.

The object may be a car key or a mobile device.

The system for detecting an object in a vehicle based on UWB may comprise: a search button that is provided on a vehicle handle and electrically connected to the vehicle-mounted display device, in which the search button may be configured to generate a search request signal for searching for the object when the search button is pressed and transmit the generated search request signal to the vehicle-mounted display device, the vehicle-mounted display device may be further configured to transmit the received search request signal to the vehicle-mounted control device when receiving the search request signal from the search button, provide the voice prompt information when a search result signal received from the vehicle-mounted control device is a signal indicating that there is no object in the vehicle, and display a location icon and/or the voice prompt information of the object in the vehicle when the search result signal received from the vehicle-mounted control device is a signal indicating that there is the object in the vehicle, the vehicle-mounted control device may be further configured to transmit a search command to the vehicle-mounted UWB communication device when receiving the search request signal from the vehicle-mounted display device, and transmit the received search result signal to the vehicle-mounted display device when the search result signal is received from the vehicle-mounted UWB communication device, and the vehicle-mounted UWB communication device may be further configured to perform the UWB communication with the object when receiving the search command from the vehicle-mounted control device, determine whether the object is present in the vehicle and the location information of the object, and transmit the search result signal to the vehicle-mounted control device.

The system for detecting an object in a vehicle based on UWB may comprise: a door lock button that is installed on an outer handle of a vehicle door and electrically connected to the vehicle-mounted control device, in which the door lock button may be configured to detect whether the door lock button is touched, generate a touch signal when the door lock button is detected to be touched, and transmit the generated touch signal to the vehicle-mounted control device, and the vehicle-mounted control device may be further configured to determine whether the touch signal is received from the door lock button, and, if it is determined that the touch signal is received from the door lock button, cause a buzzer to sound an alarm when the object is located in the vehicle, and display the location of the object on the vehicle-mounted display device.

Before determining whether the touch signal is received from the door lock button, the vehicle-mounted control device may be further configured to detect whether a vehicle starting is turned off, determine whether at least one vehicle door is opened and then closed if it is determined that the vehicle starting is turned off, and determine whether all the doors are closed if it is determined that the at least one vehicle door is opened and then closed.

The vehicle-mounted control device may be further configured not to determine whether the touch signal is received from the door lock button if it is determined that the vehicle starting is not turned off, if it is determined that the at least one vehicle door is opened and then not closed, or if it is determined that any one vehicle door is not closed.

When determining that the touch signal has been received from the door lock button, the vehicle-mounted control device may be further configured to transmit the search command to the vehicle-mounted UWB communication device, and when the search result signal is received from the vehicle-mounted UWB communication device, the vehicle-mounted control device may be further configured to transmit the received search result signal to the vehicle-mounted display device, when receiving the search command from the vehicle-mounted control device, the vehicle-mounted UWB communication device may perform the UWB communication with the object in the vehicle to determine whether there is the object in the vehicle and the location information of the object, and transmit the search result signal to the vehicle-mounted control device, and when the search result signal received from the vehicle-mounted control device is the signal indicating that there is no object in the vehicle, the vehicle-mounted display device may be further configured to provide the voice prompt information, and when the search result signal received from the vehicle-mounted control device is the signal indicating that there is the object in the vehicle, the vehicle-mounted display device may be further configured to display the location icon and/or the voice prompt information of the object in the vehicle.

The mobile device may comprise a Bluetooth® communication module and transmits and receives a Bluetooth® communication signal, and the vehicle-mounted display device may comprise a vehicle-mounted Bluetooth® communication module and a touch panel, the vehicle-mounted Bluetooth® communication module may perform the Bluetooth® communication with the mobile device, and the vehicle-mounted display device may be further configured to perform the Bluetooth® communication with the touched mobile device in response to the location icon of the mobile device being touched on the three-dimensional image of the vehicle displayed on the touch panel.

A display posture of the vehicle and a display angle of the object may be adjusted by touching the touch panel in the three-dimensional image of the vehicle displayed on the touch panel.

The number of the plurality of vehicle-mounted UWB communication modules may be 5, and the plurality of vehicle-mounted UWB communication modules may each be installed at a left front corner, a right front corner, a left rear corner, a right rear corner, and a position of a roof close to a front of the vehicle, and the vehicle-mounted communication signal may comprise a wired communication signal.

According to an exemplary embodiment of the present disclosure, there is provided a method for detecting an object in a vehicle based on ultra-wideband (UWB). The method for detecting an object in a vehicle based on ultra-wideband (UWB) comprises: transmitting and receiving a UWB communication signal by an object in the vehicle; determining location information of the object in the vehicle based on the UWB communication signal received by a vehicle-mounted UWB communication device; converting the location information of the object determined by the vehicle-mounted UWB communication device into a vehicle-mounted communication signal; generating, by the vehicle-mounted control device, a corresponding control signal based on the vehicle-mounted communication signal of the vehicle-mounted UWB communication device; and displaying, by a vehicle-mounted display device, a three-dimensional image of the vehicle and a location icon and/or a voice prompt information of the object in the vehicle based on the control signal of the vehicle-mounted control device.

The object may be a car key or a mobile device.

The method for detecting an object in a vehicle based on UWB may comprise: when a search button is pressed, generating a search request signal for searching for the object in the vehicle; transmitting the generated search request signal to the vehicle-mounted display device; when receiving the search request signal from a search button, transmitting the search request signal received by the vehicle-mounted display device to the vehicle-mounted control device; when the search result signal received from the vehicle-mounted control device is a signal indicating that there is no object in the vehicle, providing the voice prompt information by the vehicle-mounted display device; when the search result signal received from the vehicle-mounted control device is a signal indicating that there is the object in the vehicle, displaying, by the vehicle-mounted display device, the location icon and/or the voice prompt information of the object in the vehicle; when receiving the search request signal from the vehicle-mounted display device, transmitting, by the vehicle-mounted control device, a search command to the vehicle-mounted UWB communication device; when receiving the search result signal from the vehicle-mounted UWB communication device, transmitting the search result signal received by the vehicle-mounted control device to the vehicle-mounted display device; when receiving the search command from the vehicle-mounted control device, determining, by the vehicle-mounted UWB communication device, whether there is the object in the vehicle and the location information of the object; and transmitting, by the vehicle-mounted UWB communication device, the search result signal to the vehicle-mounted control device.

The method for detecting an object in a vehicle based on UWB may comprise: detecting whether a door lock button is touched by a door lock button; generating a touch signal by the door lock button if it is detected that the door lock button is touched; transmitting the touch signal generated by the door lock button to the vehicle-mounted control device; determining whether the touch signal is received from the door lock button by the vehicle-mounted control device; and if it is determined that the touch signal is received from the door lock button, when the object is located in the vehicle, causing a buzzer to sound an alarm by the vehicle-mounted control device and causing the vehicle-mounted display device to display the location of the object in the vehicle.

The method for detecting an object in a vehicle based on UWB may comprise: before determining whether the touch signal is received from the door lock button, by the vehicle-mounted control device, detecting whether the vehicle starting is turned off, if it is determined that the vehicle starting is turned off, determining whether at least one vehicle door is opened and then closed, and if it is determined that the at least one vehicle door is opened and then closed, determining whether all the doors are closed.

If it is determined that the vehicle starting is not turned off, the at least one vehicle door is determined to be opened and then not closed, or any one vehicle door is determined not to be closed, it may not be determined whether the touch signal is received from the door lock button.

The method for detecting an object in a vehicle based on UWB may comprise: if it is determined that the touch signal is received from the door lock button, transmitting, by the vehicle-mounted control device, the search command to the vehicle-mounted UWB communication device; when receiving the search result signal from the vehicle-mounted UWB communication device, transmitting the search result signal received by the vehicle-mounted control device to the vehicle-mounted display device; when receiving the search command from the vehicle-mounted control device, determining, by the vehicle-mounted UWB communication device, whether there is the object in the vehicle and the location information of the object; transmitting, by the vehicle-mounted UWB communication device, the search result signal to the vehicle-mounted control device; when the search result signal received from the vehicle-mounted control device is the signal indicating that there is no object in the vehicle, providing the voice prompt information by the vehicle-mounted display device; and when the search result signal received from the vehicle-mounted control device is the signal indicating that there is the object in the vehicle, displaying, by the vehicle-mounted display device, the location icon and/or the voice prompt information of the object in the vehicle.

When the location icon of the mobile device is touched in the three-dimensional image of the vehicle displayed on the touch panel of the vehicle-mounted display device, the vehicle-mounted display device and the touched mobile device may perform Bluetooth® communication.

A display posture of the vehicle and a display angle of the object may be adjusted by touching the touch panel in the three-dimensional image of the vehicle displayed on the touch panel of the vehicle-mounted display device.

A plurality of vehicle-mounted UWB communication modules may be installed in the vehicle-mounted UWB communication device, the number of the plurality of vehicle-mounted UWB communication modules may be 5, and the plurality of vehicle-mounted UWB communication modules may each be installed at a left front corner, a right front corner, a left rear corner, a right rear corner, and a position of a roof close to a front of the vehicle, and the vehicle-mounted communication signal may comprise a wired communication signal.

The present disclosure uses the above-described technical solution, and the beneficial effects are as follows.

According to the system and the method for detecting the object such as the car key or the mobile device based on the UWB according to the exemplary embodiment of the present disclosure, it is possible to accurately detect the location of the car key or the mobile device through the body domain control device and the UWB communication module installed in the vehicle. The audio, video, navigation, and telematics (AVNT) devices display the three-dimensional image of the vehicle and the location icon and/or the voice prompt information of the car key and/or the mobile device in the vehicle, so the driver and the passengers can quickly and clearly obtain the location information and/or the voice information of the car key and/or the mobile device in the vehicle.

The system and the method for detecting the object such as the car key or the mobile device based on the UWB according to the exemplary embodiment of the present disclosure further has the one-click connection function. When the location icon of the mobile device is touched on the three-dimensional image of the vehicle displayed on the vehicle-mounted display device, the vehicle-mounted display device and the mobile device touched by the location icon directly perform the Bluetooth® communication, thereby simplifying the Bluetooth® connection processes. Therefore, the conventional complicated operation for opening the Bluetooth® function using the setting function, finding the corresponding Bluetooth name in the list, and connecting to the Bluetooth® is replaced with the one click.

According to the system and the method for detecting the object such as the car key or the mobile device based on the UWB of the exemplary embodiment of the present disclosure, when the vehicle starting is turned off the car key and/or the mobile device are left in the vehicle, and then the door lock button on the outer handle of the vehicle door is pressed, not only does the buzzer sound, but the vehicle-mounted display device may also display the image and/or voice prompt information of the in-vehicle location of the car key and/or the mobile device. As a result, it is possible to help the driver quickly find the car key and/or the mobile device lost or forgotten in the vehicle, thereby improving the convenience and safety.

In further aspects, vehicles are provided that comprise a system for detecting object in a vehicle based on ultra-wideband (UWB) as disclosed herein.

Other effects that may be obtained or are predicted by an exemplary embodiment will be explicitly or implicitly described in a detailed description of an exemplary embodiment. That is, various effects that are predicted according to an exemplary embodiment will be described in the following detailed description.

### BRIEF DESCRIPTION OF THE DRAWINGS

Hereinafter, exemplary embodiments of the present disclosure will be described in more detail with reference to the attached drawings. For clarity, identical parts are indicated by the same reference numerals in different drawings. It should be noted that the drawings are schematic and not necessarily drawn to scale.

FIG. 1 is a block diagram illustrating a system for detecting an object, such as a car key or a mobile device, based on ultra-wideband (UWB), according to an exemplary embodiment of the present disclosure.

FIG. 2 is a flowchart illustrating a method for detecting an object, such as a car key or a mobile device, based on UWB, according to an exemplary embodiment of the present disclosure.

FIG. 3 is a flowchart illustrating a method for detecting an object, such as a car key or a mobile device, based on UWB, according to another exemplary embodiment of the present disclosure.

### DETAILED DESCRIPTION OF THE EMBODIMENTS

Hereinafter, the exemplary embodiment of the present disclosure will be described in detail. This exemplary embodiment is implemented based on the technical solution of the present disclosure, and shows a specific implementation method and a specific operation process, but the protection scope of the present disclosure is not limited to the exemplary embodiment below.

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as: a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

Hereinafter, exemplary embodiments of the present disclosure will be described in detail with reference to the attached drawings.

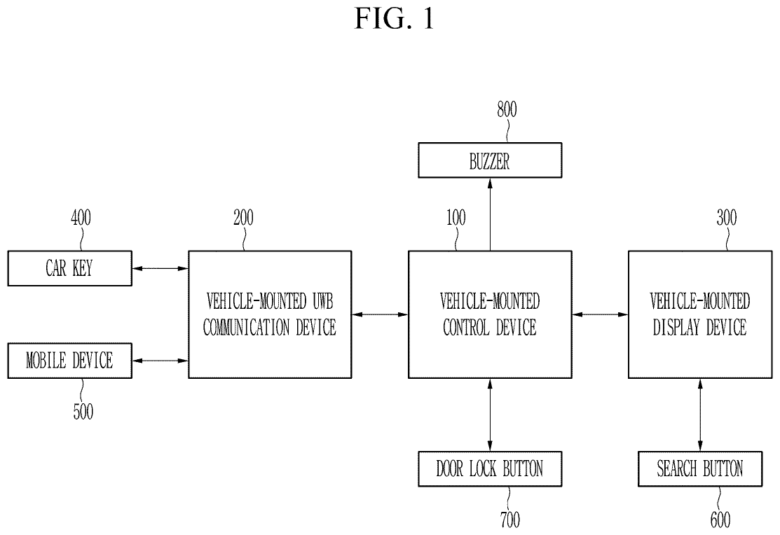

Referring now to FIG. 1, a block diagram of a system for detecting an object, such as a car key or a mobile device, based on ultra-wideband (UWB) is illustratively depicted, according to an embodiment of the present disclosure. The system for detecting the object, such as the car key or the mobile device, based on the UWB according to the exemplary embodiment of the present disclosure, may comprise a vehicle-mounted control device 100, a vehicle-mounted UWB communication device 200, a vehicle-mounted display device 300, and the car key 400 or the mobile device 500.

The car key 400 and the mobile device 500 may each comprise a UWB communication module and may each be configured to transmit and receive a UWB communication signal. That is, the car key 400 and the mobile device 500 may each be configured to perform UWB communication. The mobile device may comprise any portable mobile device such as, e.g., a mobile phone and a tablet.

The UWB technology is a wireless communication technology that transmits data using a narrow pulse at a nanosecond level. The UWB technology realizes precise positioning at a centimeter level, provides safe data communication at a speed of up to 27 Mbps, and has very low power consumption and delay. A high bandwidth and low power spectral density may share frequency spectrum with other narrowband and wideband wireless communication systems, and have certain interference prevention performance.

The vehicle-mounted UWB communication device 200 may comprise a UWB processing module and a plurality of vehicle-mounted UWB communication modules. The UWB processing module may be connected to the plurality of vehicle-mounted UWB communication modules through a wired communication manner, respectively. The plurality of vehicle-mounted UWB communication modules may be configured to perform the UWB communication with the car key 400 and the mobile device 500, respectively, and transmit the received UWB communication signal of the car key 400 and/or the mobile device 500 to the UWB processing module. The UWB processing module may be configured to determine location information of the car key 400 and/or the mobile device 500 based on the received UWB communication signal of the car key 400 and/or the mobile device 500, and convert the determined location information of the car key 400 and/or the mobile device 500 into the vehicle-mounted communication signal.

The number of the plurality of vehicle-mounted UWB communication modules may be 3, 4, 5, 6 or more. According to an exemplary embodiment of the present disclosure, the plurality of vehicle-mounted UWB communication modules may comprise 5 vehicle-mounted UWB communication modules, including a slave vehicle-mounted UWB communication module installed at a left front corner of the vehicle, a slave vehicle-mounted UWB communication module installed at a right front corner of the vehicle, a slave vehicle-mounted UWB communication module installed at a left rear corner of the vehicle, a slave vehicle-mounted UWB communication module installed at a right rear corner of the vehicle, and a master vehicle-mounted UWB communication module installed on a roof close to a front of the vehicle. However, the arrangement manner of the plurality of vehicle-mounted UWB communication modules is not limited thereto, and may vary according to the vehicle structure and actual needs.

The plurality of vehicle-mounted UWB communication modules may be communicatively connected to each other through a wired communication manner, and at least one of the plurality of vehicle-mounted UWB communication modules may be communicatively connected to the vehicle-mounted control device 100. According to an exemplary embodiment of the present disclosure, only the master vehicle-mounted UWB communication module among the plurality of vehicle-mounted UWB communication modules may be directly communicatively connected to the vehicle-mounted control device 100, and the remaining slave vehicle-mounted UWB communication modules may be communicatively connected to the master vehicle-mounted UWB communication module.

According to an exemplary embodiment, at least one of the plurality of vehicle-mounted UWB communication modules may be configured to perform communication authentication with the car key 400 and/or the mobile device 500. According to an exemplary embodiment of the present disclosure, only the master vehicle-mounted UWB communication module may be communicatively authenticated with the car key 400 and/or the mobile device 500, and the remaining slave vehicle-mounted UWB communication modules may be configured to detect the location information of the car key 400 and/or the mobile device 500.

According to an exemplary embodiment, the vehicle-mounted control device 100 may be communicatively connected to the vehicle-mounted UWB communication device 200 via a wired communication manner, and may be configured to generate the corresponding control signal based on the vehicle-mounted communication signal of the vehicle-mounted UWB communication device 200. According to an exemplary embodiment of the present disclosure, the vehicle-mounted control device 100 may comprise a body domain controller (BDC).

The vehicle-mounted display device 300 may be communicatively connected to the vehicle-mounted control device 100 via a wired communication manner, and may be configured to display a three-dimensional image of the vehicle, a location icon of the car key 400 and/or the mobile device 500 in the vehicle, or provide voice prompt information based on the control signal of the vehicle-mounted control device 100.

The vehicle-mounted display device 300 may comprise a touch panel. By touching the touch panel on the three-dimensional image of the vehicle displayed on the touch panel, a driver may view the location of the car key and/or the mobile device from various angles by adjusting a display posture of the vehicle and a display angle of the car key 400 and/or the mobile device 500.

The vehicle-mounted display device 300 may comprise a flat panel display device such as a liquid crystal display (LCD), an organic light emitting diode (OLED), and a plasma display panel (PDP). According to an exemplary embodiment of the present disclosure, the vehicle-mounted display device 300 may comprise an audio video navigation & telematics (AVNT) device. The AVNT device may implement practical functions such as an AI intelligent voice control, a remote control, a real-time interconnection of mobile phones, and a GPS navigation.

According to an exemplary embodiment of the present disclosure, the wired communication manner may comprise a controller area network (CAN), a universal serial bus (USB), a high definition multimedia interface (HDMI), a digital visual interface (DVI), etc. Here, the CAN communication may comprise a powertrain CAN (P_CAN), a body control device CAN (B_CAN), a chassis control CAN (C_CAN), etc. However, the exemplary embodiment of the present disclosure is not limited to the communication manner.

Therefore, the system for detecting the object such as the car key or the mobile device based on the UWB according to the exemplary embodiment of the present disclosure may be configured to accurately detect the location of the car key 400 and/or the mobile device 500 through the BDC and the UWB communication module installed in the vehicle. The AVNT may be configured to display the three-dimensional image of the vehicle and the location icon and/or the voice prompt information of the car key 400 and/or the mobile device 500 in the vehicle, so that the driver and passengers may quickly and clearly obtain the exact location of the car key 400 and/or the mobile device 500.

According to an exemplary embodiment, the location error may be accurate to a centimeter level, and the location of the car key 400 and/or the mobile device 500 may be observed from various angles.

The system for detecting the object such as the car key or the mobile device based on the UWB according to the exemplary embodiment of the present disclosure may comprise a search button 600. The search button 600 may be installed on a vehicle handle and electrically connected to the vehicle-mounted display device 300. When the search button 600 is pressed, the search button 600 may be configured to generate a search request signal for searching for the car key 400 and/or the mobile device 500, and transmit the generated search request signal to the vehicle-mounted display device 300. The vehicle-mounted display device 300 may be configured to perform communication with the vehicle-mounted UWB communication device 200 via the vehicle-mounted control device 100 to acquire information about whether the car key 400 and/or the mobile device 500 are present in the vehicle and the location information of the car key 400 and/or the mobile device 500 and provide the corresponding image and/or the voice prompt information.

In the system for detecting the object such as the car key or the mobile device based on the UWB according to an exemplary embodiment of the present disclosure, the mobile device 500 may comprise a Bluetooth® communication module and may transmit and receive a Bluetooth® communication signal. Accordingly, the vehicle-mounted display device 300 may comprise a vehicle-mounted Bluetooth® communication module, and the vehicle-mounted Bluetooth communication module may perform the Bluetooth® communication with the mobile device 500. When the location icon of the mobile device 500 is touched in the displayed three-dimensional image of the vehicle, the vehicle-mounted display device 300 and the touched mobile device 500 may be configured to perform the Bluetooth® communication. For example, when the driver wants to make a Bluetooth® connection with the passenger's mobile device 500, a one-click connection function may be used to implement the Bluetooth® connection with the corresponding mobile device 500. Accordingly, music of the passenger's mobile device 500 may be shared and a passenger's address book may be checked.

Therefore, the system for detecting the object, such as the car key or the mobile device, based on the UWB according to the exemplary embodiment of the present disclosure may comprise the one-click connection function. That is, when the location icon of the mobile device 500 is touched in the displayed three-dimensional image of the vehicle, the vehicle-mounted display device 300 and the touched mobile device 500 may be configured to directly perform the Bluetooth® communication, thereby simplifying the Bluetooth® connection processes. Therefore, the existing complicated operation of opening the Bluetooth® function using the setting function, finding the corresponding Bluetooth® name in the list, and connecting to the Bluetooth® has been overcome.

The system for detecting the object such as the car key or the mobile device based on the UWB according to the exemplary embodiment of the present disclosure may comprise a door lock button 700. The door lock button 700 may be provided on an outer handle of a vehicle door and electrically connected to the vehicle-mounted control device 100. The door lock button 700 is configured to detect whether the door lock button 700 is touched. If it is detected that the door lock button 700 is touched, the door lock button 700 may be configured to generate a touch signal and transmit the generated touch signal to the vehicle-mounted control device 100. The vehicle-mounted control device 100 may be configured to communicate with the vehicle-mounted UWB communication device 200 to acquire the information on whether the car key 400 and/or the mobile device 500 are in the vehicle and the location information of the car key 400 and/or the mobile device 500. When the car key 400 and/or the mobile device 500 are located inside the vehicle, a buzzer 800 may be configured to sound an alarm sound, and the vehicle-mounted display device 300 may be configured to provide the corresponding image and/or the voice prompt information.

The buzzer 800 may be electrically connected to the vehicle-mounted control device 100, and the vehicle-mounted control device 100 may be configured to transmit a trigger signal to the buzzer 800 to cause the buzzer 800 to sound the alarm sound.

Therefore, according to the system for detecting the object, such as the car key or the mobile device, based on the UWB according to the exemplary embodiment of the present disclosure, when the vehicle starting is turned off and the car key 400 and/or the mobile device 500 are left in the vehicle, when the door lock button 700 on the outer handle of the vehicle door is pressed, not only may the buzzer 800 be configured to sound the alarm, but also the vehicle-mounted display device 300 may be configured to display the location image and/or the voice prompt information of the car key 400 and/or the mobile device 500 in the vehicle. As a result, it is possible to help the driver quickly find the car key 400 and/or the mobile device 500 lost or forgotten in the vehicle, thereby improving the convenience and safety.

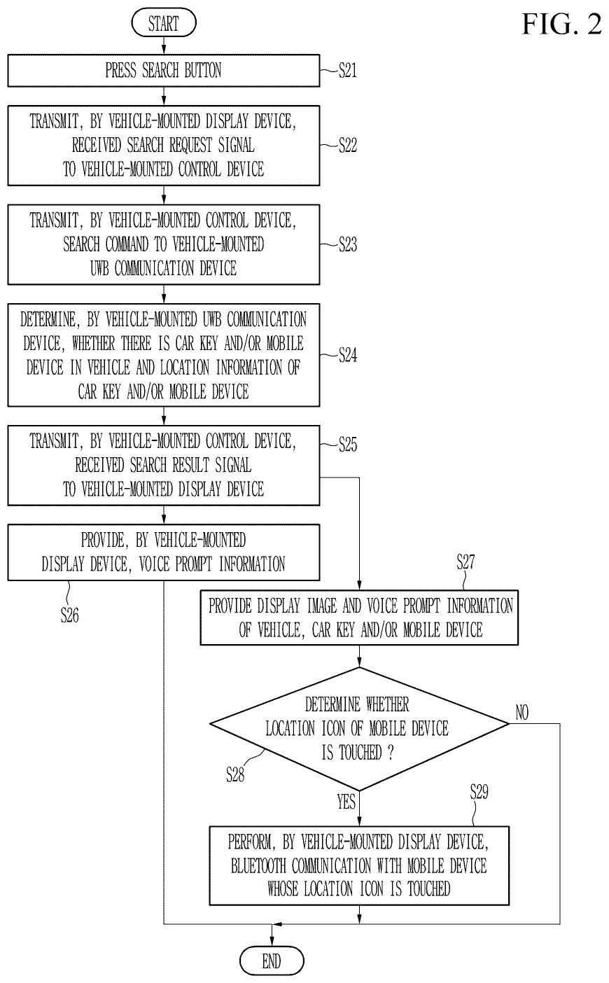

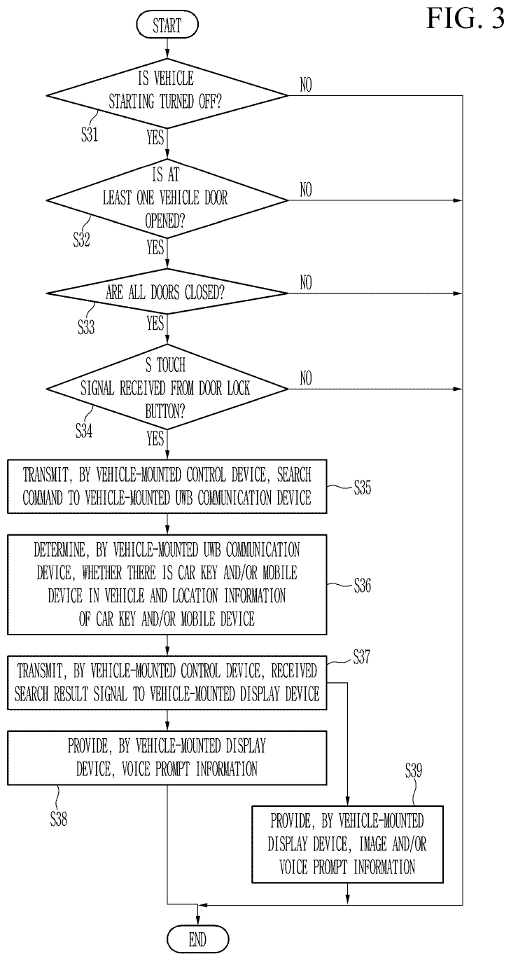

Referring to FIGS. 2 and 3, a processing process of a method for detecting an object, such as a car key or a mobile device, based on UWB is described according to a specific example.

FIG. 2 illustrates a process of searching for the car key 400 and/or the mobile device 500 by pressing the search button 600. Referring to FIG. 2, in step S21, when the search button 600 is pressed, the search button 600 may be configured to generate the search request signal for searching for the car key 400 and/or the mobile device 500, and transmit the generated search request signal to the vehicle-mounted display device 300.

In step S22, when the vehicle-mounted display device 300 receives the search request signal from the search button 600, the vehicle-mounted display device 300 may be configured to transmit the received search request signal to the vehicle-mounted control device 100.

In step S23, when receiving the search request signal from the vehicle-mounted display device 300, the vehicle-mounted control device 100 may be configured to transmit a search command to the vehicle-mounted UWB communication device 200.

In step S24, when the search command is received from the vehicle-mounted control device 100, the vehicle-mounted UWB communication device 200 may be configured to perform the UWB communication with the car key 400 and/or the mobile device 500 in the vehicle to determine whether the car key 400 and/or mobile device 500 is present in the vehicle and the location information of the car key 400 and/or mobile device 500, and may be configured to transmit the search result signal to the vehicle-mounted control device 100.

In step S25, when the search result signal is received from the vehicle-mounted UWB communication device 200, the vehicle-mounted control device 100 may be configured to transmit the received search result signal to the vehicle-mounted display device 300.

In step S26, when the search result signal received from the vehicle-mounted control device 100 is a signal indicating that there is no car key 400 and mobile device 500 in the vehicle, the vehicle-mounted display device 300 may be configured to provide the voice prompt information such as “there is no car key 400 and mobile device 500 in the vehicle”.

In step S27, when the search result signal received from the vehicle-mounted control device 100 is a signal indicating that there is the car key 400 and/or the mobile device 500 in the vehicle, the vehicle-mounted display device 300 may be configured to provide the display image and/or the voice prompt information such as the three-dimensional image of the vehicle and the location icon and/or the voice prompt information of the car key 400 and/or the mobile device 500 in the vehicle.

In step S28, the vehicle-mounted display device 300 may be configured to determine whether the location icon of the mobile device 500 has been touched.

In step S29, when the location icon of the mobile device 500 is touched, the vehicle-mounted display device 300 and the mobile device 400 whose location icon is touched may be configured to perform the Bluetooth® communication.

Therefore, the method for detecting the object, such as the car key or the mobile device, based on the UWB according to the exemplary embodiment of the present disclosure may be configured to accurately detect the location of the car key 400 and/or the mobile device 500 through the vehicle-mounted control device 100 and the vehicle-mounted UWB communication module, and the vehicle-mounted display device 300 may be configured to display the three-dimensional image of the vehicle and the location icon and/or the voice prompt information of the car key 400 and/or the mobile device 500 in the vehicle, so the driver and the passengers may quickly and clearly obtain the exact location of the car key 400 and/or the mobile device 500. According to an exemplary embodiment, when the driver wants to change the Bluetooth® connection of the vehicle and the mobile device 400 while driving the vehicle, the search button 600 may be configured to be pressed to cause the vehicle-mounted UWB communication module to search for the car key 400 and/or the mobile device 500. Thereafter, since all the mobile devices 500 in the vehicle are displayed on the vehicle-mounted display device 300, the system and method may be configured to enable the driver to connect the corresponding mobile device 500 to the Bluetooth® by simply touching the mobile device icon on the vehicle-mounted display device 300.

FIG. 3 illustrates a process of searching for the car key 400 and/or the mobile device 500 using the door lock button 700. Referring to FIG. 3, in step S31, it may be detected whether the vehicle starting is turned off by the vehicle-mounted control device 100. If it is determined that the vehicle starting is turned off, in step S32, it may be determined whether at least one vehicle door is opened or closed by the vehicle-mounted control device 100. If it is determined that at least one vehicle door is opened and closed, it may be determined in step S33 whether all the doors are closed by the vehicle-mounted control device 100. Through the above-described series of determination, it may be determined whether the driver and/or the passengers of the vehicle have gotten out of the vehicle when the vehicle starting is turned off.

In step S34, the vehicle-mounted control device 100 may be configured to determine whether the touch signal is received from the door lock button 700. If it is determined that the vehicle starting is turned off, at least one vehicle door is opened and closed, and all the vehicle doors are closed (i.e., the driver and/or the passengers of the vehicle have gotten out of the vehicle while the vehicle starting is turned off), it may be determined whether the door lock button 700 of the outer handle of the vehicle door has been touched to determine whether the driver and/or the passengers want to lock the vehicle.

If it is determined that the vehicle starting is not turned off, at least one vehicle door is determined to be opened and then not closed, or any one vehicle door is determined not to be closed, a subsequent determination, that is, the determination on whether the touch signal is received from the door lock button 700, may not be made.

If it is determined that the touch signal is received from the door lock button 700, the vehicle-mounted control device 100 may be configured to transmit the search command to the vehicle-mounted UWB communication device 200, in step S35.

When the search command is received from the vehicle-mounted control device 100, in step S36, the vehicle-mounted UWB communication device 200 may be configured to perform the UWB communication with the car key 400 and/or the mobile device 500 to determine whether the car key 400 and/or the mobile device 500 is present in the vehicle and the location information of the car key 400 and/or the mobile device 500, and may be configured to transmit the search result signal to the vehicle-mounted control device 100.

In step S37, when the search result signal is received from the vehicle-mounted UWB communication device 200, the vehicle-mounted control device 100 may be configured to transmit the received search result signal to the vehicle-mounted display device 300.

In step S38, when the search result signal received from the vehicle-mounted control device 100 is the signal indicating that there is no car key 400 and mobile device 500 in the vehicle, the vehicle-mounted display device 300 may be configured to provide the voice prompt information such as “there is no car key 400 and mobile device 500 in the vehicle”.

In step S39, when the search result signal received from the vehicle-mounted control device 100 is the signal indicating that there is the car key 400 and/or the mobile device 500 in the vehicle, the vehicle-mounted display device 300 may be configured to provide the image and/or the voice prompt information such as the three-dimensional image of the vehicle and the location icon and/or the voice prompt information of the car key 400 and/or the mobile device 500 in the vehicle.

According to the method for detecting the object such as the car key or the mobile device based on the UWB of the exemplary embodiment of the present disclosure, when the door lock button 700 on the outer handle of the vehicle door is pressed while the vehicle starting is turned off and the car key 400 and/or the mobile device 500 are left in the vehicle, it may be indicated that the driver has forgotten the car key 400 and/or the mobile device 500 in the vehicle. In this case, when the driver locks the car and wants to leave, not only the buzzer 800 may sound the alarm, but also the AVNT may display the image and/or the voice prompt information of the in-vehicle location of the car key 400 and/or the mobile device 500. It is possible to help the driver quickly find the car key 400 and/or the mobile device 500 lost or forgotten in the vehicle, thereby improving the convenience and safety.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present disclosure and its particular application and to thereby enable those skilled in the art to make and use embodiments of the disclosure. However, those skilled in the art will recognize that the foregoing description and examples have been presented for the purposes of illustration and example only. The description as set forth is not intended to be exhaustive or to limit the embodiments of the disclosure to the precise form disclosed.

What is claimed is:

1. A system for detecting an object in a vehicle based on ultra-wideband (UWB), comprising:
a vehicle-mounted UWB communication device comprising a UWB processing module and a plurality of vehicle-mounted UWB communication modules;
a vehicle-mounted control device communicatively connected to the vehicle-mounted UWB communication device; and
a vehicle-mounted display device communicatively connected to the vehicle-mounted control device,
wherein:
the object comprises a UWB communication module and is configured to transmit and receive a UWB communication signal,
the UWB processing module and the plurality of vehicle-mounted UWB communication modules are communicatively connected to each other,
the plurality of vehicle-mounted UWB communication modules are configured to perform UWB communication with the object and transmit the received UWB communication signal of the object to the UWB processing module,
the UWB processing module is configured to:
determine location information of the object based on the received UWB communication signal of the object, and
convert the determined location information of the object into a vehicle-mounted communication signal,
the vehicle-mounted control device is configured to generate a corresponding control signal based on the vehicle-mounted communication signal of the vehicle-mounted UWB communication device, and
the vehicle-mounted display device is configured to, based on the control signal of the vehicle-mounted control device, display, in the vehicle, one or more of the following:
a three-dimensional image of the vehicle;
a position icon; and
voice prompt information of the object in the vehicle.

2. The system of claim 1, wherein the object comprises a car key or a mobile device.

3. The system of claim 2, comprising:
a search button, provided on a vehicle handle, electrically connected to the vehicle-mounted display device,
wherein:
the search button is configured to:
generate a search request signal for searching for the object when the search button is pressed, and
transmit the generated search request signal to the vehicle-mounted display device,
the vehicle-mounted display device is configured to:
transmit the received search request signal to the vehicle-mounted control device when receiving the search request signal from the search button,
provide the voice prompt information when a search result signal received from the vehicle-mounted control device is a signal indicating that there is no object in the vehicle, and
display a location icon and/or the voice prompt information of the object in the vehicle when the search result signal received from the vehicle-mounted control device is a signal indicating that there is the object in the vehicle,
the vehicle-mounted control device is configured to:
transmit a search command to the vehicle-mounted UWB communication device when receiving the search request signal from the vehicle-mounted display device, and
when the search result signal is received from the vehicle-mounted UWB communication device, transmit the received search result signal to the vehicle-mounted display device, and
the vehicle-mounted UWB communication device is configured to:
perform the UWB communication with the object when receiving the search command from the vehicle-mounted control device, determine whether the object is present in the vehicle and the location information of the object, and transmit the search result signal to the vehicle-mounted control device.

4. The system of claim 3, comprising:
a door lock button that is installed on an outer handle of a vehicle door and electrically connected to the vehicle-mounted control device,
wherein:
the door lock button is configured to:
detect whether the door lock button is touched,
generate a touch signal when the door lock button is detected to be touched, and
transmit the generated touch signal to the vehicle-mounted control device, and
the vehicle-mounted control device is configured to:
determine whether the touch signal is received from the door lock button,
when it is determined that the touch signal is received from the door lock button, cause a buzzer to sound an alarm when the object is located in the vehicle, and
display the location of the object on the vehicle-mounted display device.

5. The system of claim 4, wherein, before determining whether the touch signal is received from the door lock button, the vehicle-mounted control device is configured to:
detect whether a vehicle starting is turned off,
when it is determined that the vehicle starting is turned off, determine whether at least one vehicle door is opened and then closed, and
when it is determined that the at least one vehicle door is opened and then closed, determine whether all the doors are closed.

6. The system of claim 5, wherein the vehicle-mounted control device is configured not to determine whether the touch signal is received from the door lock button when it is determined that:
the vehicle starting is not turned off,
the at least one vehicle door is opened and then not closed, or
any one vehicle door is not closed.

7. The system of claim 4, wherein:
when determining that the touch signal has been received from the door lock button, the vehicle-mounted control device is configured to transmit the search command to the vehicle-mounted UWB communication device,
when the search result signal is received from the vehicle-mounted UWB communication device, the vehicle-mounted control device is configured to transmit the received search result signal to the vehicle-mounted display device,
when receiving the search command from the vehicle-mounted control device, the vehicle-mounted UWB communication device is configured to:
perform the UWB communication with the object in the vehicle to determine whether there is the object in the vehicle and the location information of the object, and
transmit the search result signal to the vehicle-mounted control device,
when the search result signal received from the vehicle-mounted control device is the signal indicating that there is no object in the vehicle, the vehicle-mounted display device is configured to provide the voice prompt information, and
when the search result signal received from the vehicle-mounted control device is the signal indicating that there is the object in the vehicle, the vehicle-mounted display device is configured to display the location icon and/or the voice prompt information of the object in the vehicle.

8. The system of claim 2, wherein:
the mobile device comprises a Bluetooth® communication module and is configured to transmit and receive a Bluetooth® communication signal,
the vehicle-mounted display device further comprises a vehicle-mounted Bluetooth® communication module and a touch panel,
the vehicle-mounted Bluetooth® communication module is configured to perform the Bluetooth® communication with the mobile device, and
the vehicle-mounted display device is configured to perform the Bluetooth® communication with the touched mobile device in response to the location icon of the mobile device being touched on the three-dimensional image of the vehicle displayed on the touch panel.

9. The system of claim 8, wherein a display posture of the vehicle and a display angle of the object are configured to be adjusted by touching the touch panel in the three-dimensional image of the vehicle displayed on the touch panel.

10. The system of claim 1, wherein:
the number of the plurality of vehicle-mounted UWB communication modules is 5,
the plurality of vehicle-mounted UWB communication modules are each installed at a left front corner, a right front corner, a left rear corner, a right rear corner, and a position of a roof close to a front of the vehicle, and
the vehicle-mounted communication signal comprises a wired communication signal.

11. A method for detecting an object in a vehicle based on ultra-wideband (UWB), comprising:
transmitting and receiving a UWB communication signal by an object in the vehicle;
determining location information of the object in the vehicle based on the UWB communication signal received by a vehicle-mounted UWB communication device;
converting the location information of the object determined by the vehicle-mounted UWB communication device into a vehicle-mounted communication signal;
generating, by the vehicle-mounted control device, a corresponding control signal based on the vehicle-mounted communication signal of the vehicle-mounted UWB communication device; and
displaying, by a vehicle-mounted display device, based on the control signal of the vehicle-mounted control device, one or more of the following:
a three-dimensional image of the vehicle;
a location icon; or
voice prompt information of the object in the vehicle.

12. The method of claim 11, wherein the object comprises a car key or a mobile device.

13. The method of claim 12, further comprising:
when a search button is pressed, generating a search request signal for searching for the object in the vehicle;
transmitting the generated search request signal to the vehicle-mounted display device;
when receiving the search request signal from a search button, transmitting the search request signal received by the vehicle-mounted display device to the vehicle-mounted control device;
when the search result signal received from the vehicle-mounted control device is a signal indicating that there is no object in the vehicle, providing the voice prompt information by the vehicle-mounted display device;
when the search result signal received from the vehicle-mounted control device is a signal indicating that there is the object in the vehicle, displaying, by the vehicle-mounted display device, the location icon or the voice prompt information of the object in the vehicle;
when receiving the search request signal from the vehicle-mounted display device, transmitting, by the vehicle-mounted control device, a search command to the vehicle-mounted UWB communication device;
when receiving the search result signal from the vehicle-mounted UWB communication device, transmitting the search result signal received by the vehicle-mounted control device to the vehicle-mounted display device;
when receiving the search command from the vehicle-mounted control device, determining, by the vehicle-mounted UWB communication device, whether there is the object in the vehicle and the location information of the object; and
transmitting, by the vehicle-mounted UWB communication device, the search result signal to the vehicle-mounted control device.

14. The method of claim 13, further comprising:
detecting whether a door lock button is touched by a door lock button;
generating a touch signal by the door lock button if it is detected that the door lock button is touched;
transmitting the touch signal generated by the door lock button to the vehicle-mounted control device;
determining whether the touch signal is received from the door lock button by the vehicle-mounted control device; and
when it is determined that the touch signal is received from the door lock button, when the object is located in the vehicle:
causing a buzzer to sound an alarm by the vehicle-mounted control device, and
causing the vehicle-mounted display device to display the location of the object in the vehicle.

15. The method of claim 14, further comprising:
before determining whether the touch signal is received from the door lock button, by the vehicle-mounted control device:
detecting whether the vehicle starting is turned off,
when it is determined that the vehicle starting is turned off, determining whether at least one vehicle door is opened and then closed, and
when it is determined that the at least one vehicle door is opened and then closed, determining whether all the doors are closed.

16. The method of claim 15, wherein it is not determined whether the touch signal is received from the door lock button when it is determined that the vehicle starting is not turned off, the at least one vehicle door is determined to be opened and then not closed, or any one vehicle door is determined not to be closed.

17. The method of claim 14, further comprising:
when it is determined that the touch signal is received from the door lock button, transmitting, by the vehicle-mounted control device, the search command to the vehicle-mounted UWB communication device;
when receiving the search result signal from the vehicle-mounted UWB communication device, transmitting the search result signal received by the vehicle-mounted control device to the vehicle-mounted display device;
when receiving the search command from the vehicle-mounted control device, determining, by the vehicle-mounted UWB communication device, whether there is the object in the vehicle and the location information of the object;
transmitting, by the vehicle-mounted UWB communication device, the search result signal to the vehicle-mounted control device;
when the search result signal received from the vehicle-mounted control device is the signal indicating that there is no object in the vehicle, providing the voice prompt information by the vehicle-mounted display device; and
when the search result signal received from the vehicle-mounted control device is the signal indicating that there is the object in the vehicle, displaying, by the vehicle-mounted display device, the location icon and/or the voice prompt information of the object in the vehicle.

18. The method of claim 12, wherein, when the location icon of the mobile device is touched in the three-dimensional image of the vehicle displayed on the touch panel of the vehicle-mounted display device, the vehicle-mounted display device and the touched mobile device perform Bluetooth® communication.

19. The method of claim 18, wherein a display posture of the vehicle and a display angle of the object are configured to be adjusted by touching the touch panel in the three-dimensional image of the vehicle displayed on the touch panel of the vehicle-mounted display device.

20. A vehicle comprising a system of claim 1.
